(19) United States
(12) Patent Application Publication
(10) Pub. No.: US 2011/0274451 A1
(43) Pub. Date: Nov. 10, 2011

(54) IMAGE FORMING APPARATUS AND IMAGE FORMING METHOD

(75) Inventor: Hiroshi Kawaguchi, Kanagawa (JP)

(73) Assignees: TOSHIBA TEC KABUSHIKI KAISHA, Tokyo (JP); KABUSHIKI KAISHA TOSHIBA, Tokyo (JP)

(21) Appl. No.: 13/042,593

(22) Filed: Mar. 8, 2011

Related U.S. Application Data
(60) Provisional application No. 61/331,129, filed on May 4, 2010.

(51) Int. Cl. G03G 15/00

(52) U.S. Cl. 399/38; 399/44

(57) ABSTRACT

According to one embodiment, an image forming apparatus includes: plural image forming units including developing devices configured to respectively form images of plural colors; plural toner cartridges in which respective toner of the plural colors is stored respectively and each of the plural toner cartridges configured to supply the respective toner to the developing device respectively; first memories provided respectively incidental to the plural toner cartridges and each of the first memories in which correspondence data between parameter value affecting printing condition and printing condition calculated on the basis of characteristic of the respective toner of the plural colors is stored in advance; a detecting mechanism configured to detect the parameter value; and an arithmetic control mechanism configured to calculate each of printing conditions in the respective toner of plural colors from the correspondence data on the basis of the parameter value and calculate control condition for the image of the plural colors formed to be superimposed one on top of another on the basis of the printing condition.

### CROSS-REFERENCE TO RELATED APPLICATION

This application is based upon and claims the benefit of priority from the prior U.S. Patent Application No. 61/331,129 filed on May 4, 2010, the entire contents of which are incorporated herein by reference.

### FIELD

Embodiments described herein relate generally to an image forming apparatus and an image forming method.

### BACKGROUND

In an image forming apparatus, in printing in a full-color mode, primary transfer onto a transfer member such as an intermediate transfer belt is performed for each of single colors, after printing of the colors ends, secondary transfer is performed in a state in which the colors are superimposed one on top of another, and, after transfer from the transfer member to a medium such as paper is performed, fixing is performed by a fixing member.

Printing conditions for the printing are controlled with respect to fluctuation in printing characteristics due to characteristics of developers, deterioration in the developers, and temperature and humidity to perform control of image quality.

In the primary transfer, the printing conditions are respectively controlled according to the characteristics of the developers of the colors.

### BRIEF DESCRIPTION OF THE DRAWINGS

FIG. 1 is a diagram of an image forming apparatus, which is a quadruple tandem color printer, according to an embodiment;

FIG. 2 is a schematic diagram of an image forming unit according to the embodiment;

FIG. 3 is a block diagram of a constituent part in which control of printing conditions according to the embodiment is performed;

FIG. 4 is a correspondence table of addresses and information contents in a memory on the image forming apparatus main body side according to the embodiment;

FIG. 5 is a correspondence table of addresses and information contents in a memory on a toner cartridge side according to the embodiment;

FIG. 6 is a flowchart of the control of the printing conditions according to the embodiment;

FIG. 7 is a table of evaluation results of transfer failures according to classifications of electric resistances of toners in examples;

FIG. 8 is a table of evaluation results of transfer failures according to classifications of electric resistances of toners in comparative examples;

FIG. 9 is a table of evaluation results of fixing failures according to classifications of softening temperatures of toners in examples; and

FIG. 10 is a table of evaluation results of fixing failures according to classifications of softening temperatures of toners in comparative examples.

### DETAILED DESCRIPTION

Reference will now be made in detail to the present embodiment of the invention, an example of which is illustrated in the accompanying drawings.

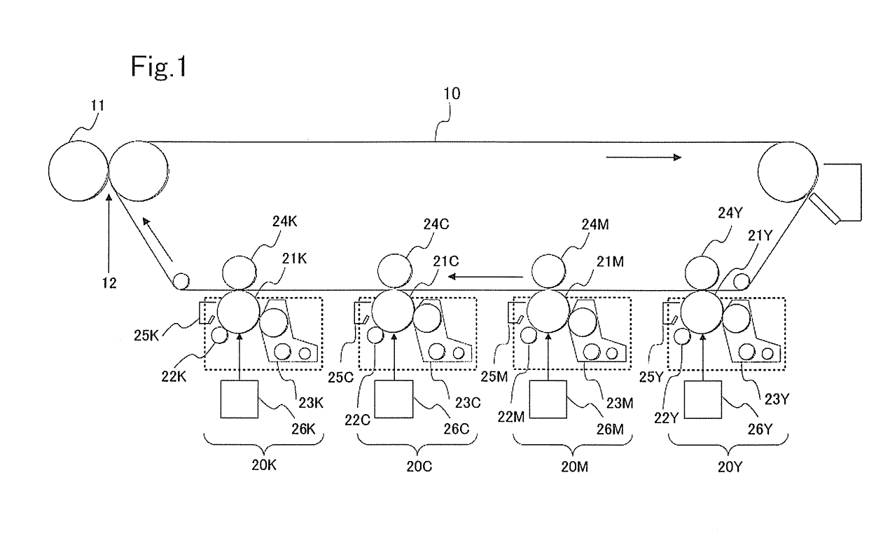

As an example of an image forming apparatus (MFP) according to an embodiment, a diagram of an image forming apparatus, which is a quadruple tandem color printer, is shown in FIG. 1. As shown in FIG. 1, a secondary transfer roller 11 for transferring an image on an intermediate transfer belt 10 onto a transfer medium 12 and image forming units 20_{Y}, 20_{M}, 20_{C}, and 20_{K} for yellow, magenta, cyan, and black are arranged along a conveying direction of the intermediate transfer belt 10 (an arrow direction).

The image forming units 20_{Y}, 20_{M}, 20_{C}, and 20_{K} respectively include photoconductive members 21_{Y}, 21_{M}, 21_{C}, and 21_{K}, which are image bearing members. Further, the image forming units 20_{Y}, 20_{M}, 20_{C}, and 20_{K} respectively include, around the photoconductive members, charging devices 22_{Y}, 22_{M}, 22_{C}, and 22_{K} serving as charging means, developing devices 23_{Y}, 23_{M}, 23_{C}, and 23_{K} including developing rollers or the like, which are developing members, and respectively having stored therein developers respectively including color toner particles of yellow, magenta, cyan, and black and carrier particles, primary transfer rollers 24_{Y}, 24_{M}, 24_{C}, and 24_{K} serving as transfer means, and cleaner units 25_{Y}, 25_{M}, 25_{C}, and 25_{K}. These devices are respectively arranged along rotating directions of the photoconductive members 21_{Y}, 21_{M}, 21_{C}, and 21_{K} corresponding to the devices.

The primary transfer rollers 24_{Y}, 24_{M}, 24_{C}, and 24_{K} are disposed on the inner side of the intermediate transfer belt 10 and nip the intermediate transfer belt 10 between the primary transfer rollers 24_{Y}, 24_{M}, 24_{C}, and 24_{K} and the photoconductive members 21_{Y}, 21_{M}, 21_{C}, and 21_{K} corresponding thereto. The exposing devices 26_{Y}, 26_{M}, 26_{C}, and 26_{K} are respectively arranged to form exposure points on the outer circumferential surfaces of the photoconductive members 21_{Y}, 21_{M}, 21_{C}, and 21_{K} between the charging devices 22_{Y}, 22_{M}, 22_{C}, and 22_{K} and the developing devices 23_{Y}, 23_{M}, 23_{C}, and 23_{K}. The secondary transfer roller 11 is arranged on the outer side of the intermediate transfer belt 10 to be in contact with the intermediate transfer belt 10.

The image forming apparatus configured as explained above performs a print operation as explained below. A toner image is formed by the image forming unit 20_{Y}. The same process is performed in the image forming units 20_{M}, 20_{C}, and 20_{K} to be timed to coincide with the toner image formation by the image forming unit 20_{Y}. The toner image of yellow formed on the photoconductive member of the image forming unit 20_{Y} is primarily transferred onto the intermediate transfer belt 10. Toner images of magenta, cyan, and black formed on the photoconductive members of the image forming units 20_{M}, 20_{C}, and 20_{K} are sequentially primarily transferred onto the intermediate transfer belt 10.

The transfer medium 12 is conveyed from a cassette (not shown) and delivered to the intermediate transfer belt 10 by an aligning roller (not shown) to be timed to coincide with the toner images on the intermediate transfer belt 10.

Bias (+) having polarity opposite to charging polarity of the toners is applied to the secondary transfer roller 11 by a power supply (not shown). As a result, the toner images on the intermediate transfer belt 10 are transferred onto the transfer medium 12 by a secondary transfer voltage applied between the intermediate transfer belt 10 and the secondary transfer roller 11. A fixing device (not shown) for fixing the toners transferred onto the transfer medium 12 is disposed. A fixed image is obtained by causing the transfer medium 12 to pass through the fixing device.

In the example explained above, the image forming units are arranged in order of the colors yellow, magenta, cyan, and black. However, this color order is not specifically limited.

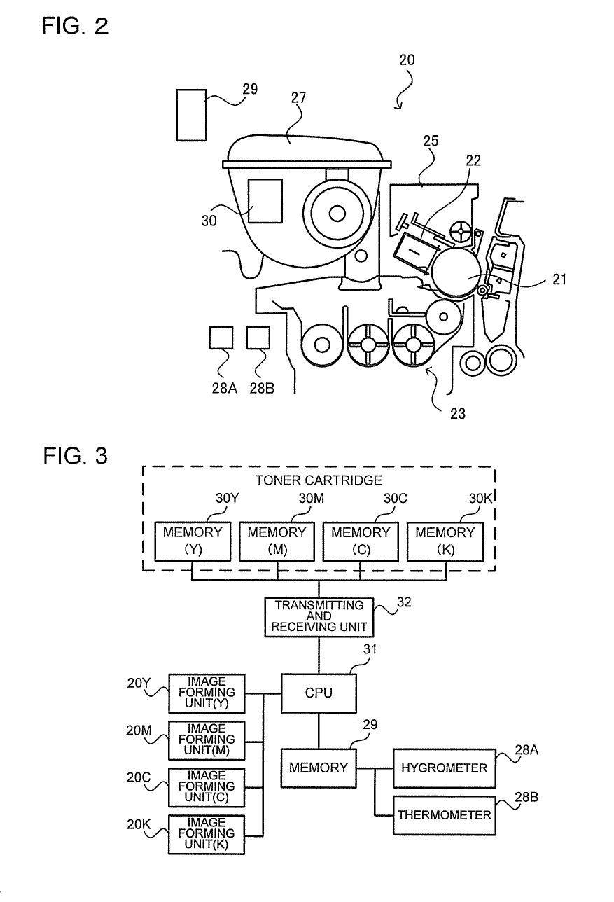

FIG. 2 is a schematic diagram of the image forming unit in an image forming apparatus 20 that is configured as explained above and in which an image is formed. The image forming units 20_{Y}, 20_{M}, 20_{C}, and 20_{K} have the same configuration.

As shown in FIG. 2, a charging device 22, a developing device 23, and a cleaner unit 25 are arranged around a photoconductive member 21. A toner cartridge 27 is inserted in the developing device 23. In an image forming apparatus main body, a hygrometer 28A and a thermometer 28B for detecting parameter values that fluctuate during printing and affect printing conditions such as humidity and temperature and a memory 29 configured to store the humidity, the temperature, and selected printing conditions explained later are provided. The hygrometer 28A, the thermometer 28B, and the memory 29 are provided in common to the image forming units 20_{Y}, 20_{M}, 20_{C}, and 20_{K}.

In the toner cartridge 27, a memory 30 is provided that has stored therein correspondence data between humidity and a secondary transfer voltage and between temperature and fixing temperature, which are optimized in advance, in a manufacturing lot of a toner stored in the toner cartridge 27.

The parameter values are the humidity and the temperature. The hygrometer 28A and the thermometer 28B for detecting the humidity and the temperature are provided. However, one of the humidity and the temperature may be the parameter value and one of the hygrometer 28A and the thermometer 28B may be provided. In this case, the correspondence data is one of the correspondence data between the humidity and the secondary transfer voltage and the correspondence data between the temperature and the fixing temperature. The parameter values only have to be parameters that affect the printing conditions and may be parameters having correlation with a deterioration state of the toner such as the number of printed sheets and the number of pixels.

The memory 30 does not always need to be attached to the toner cartridge 27. The memory 30 may be attached to an integrated unit as long as the integrated unit is an integrated unit of a developing unit including the toner cartridge 27 and a developing device.

The components of the image forming unit are respectively connected to arithmetic control mechanisms (not shown) configured to control the components.

In such an image forming unit, control of the printing conditions is performed as explained below. FIG. 3 is a block diagram of a constituent part in which the control of the printing conditions is performed. As shown in FIG. 3, a CPU 31 serving as an arithmetic control mechanism is connected to the image forming units 20_{Y}, 20_{M}, 20_{C}, and 20_{K} and the memory 29 on the main body side. The memory 29 is connected to the hygrometer 28A and the thermometer 28B.

Further, the CPU 31 is connected to memories 30_{Y}, 30_{M} 30_{C}, and 30_{K} on toner cartridge 27_{Y}, 27_{M}, 27_{C}, and 27_{K} side via a transmitting and receiving section 32 by wire or wireless communication. The CPU 31 controls the image forming apparatus including the components of the image forming units 20_{Y}, 20_{M}, 20_{C}, and 20_{K}. The CPU 31 may incorporate the memory 29.

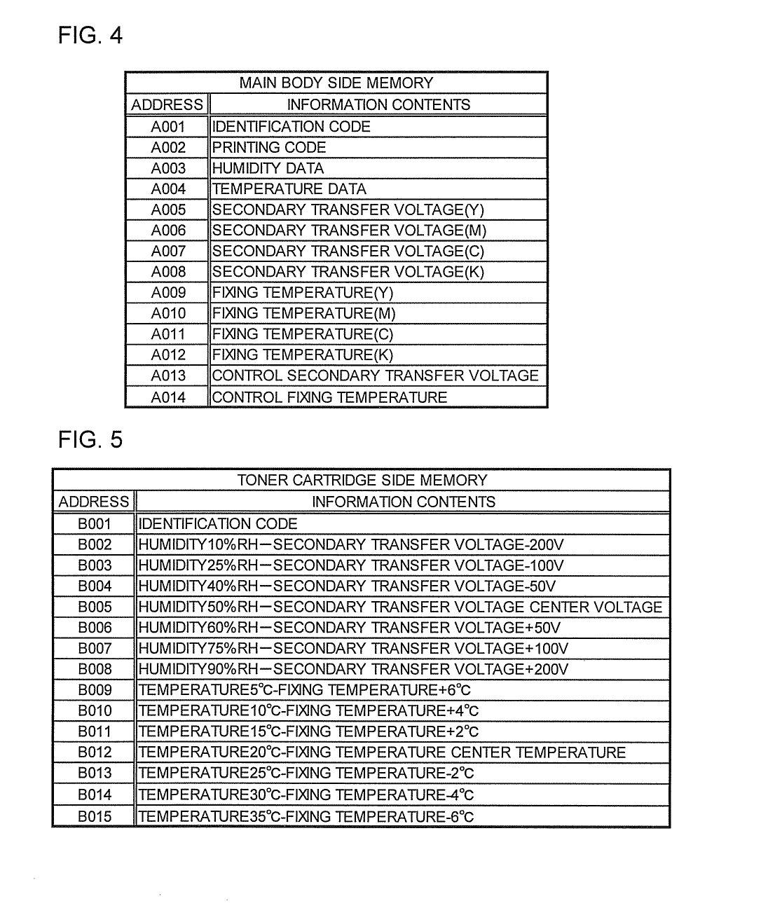

FIG. 4 is a correspondence table of addresses and information contents in the memory 29 on the main body side. FIG. 5 is a correspondence table of addresses and information contents in the memory 30 on the toner cartridge side.

As shown in the table of FIG. 4, in the memory 29 on the main body side, an area (A001) to which an identification code is input, an area (A002) in which a printing mode (monochrome, mono color, or full color) selected by a user is written, an area (A003) in which humidity data measured by the hygrometer 28A is written, and an area (A004) in which temperature data measured by the thermometer 28B is written are provided for each of the addresses.

Areas (A005 to A008) in which secondary transfer voltages selected according to humidities measured from the correspondence data between humidity and a secondary transfer voltage respectively read from memories on the toner cartridges side for the colors are written and areas (A009 to A012) in which fixing temperatures selected according to temperatures measured from the correspondence data between temperature and fixing temperature are written are provided.

Further, an area (A013) to which the secondary transfer voltage of the control conditions calculated according to a printing mode is input and an area (A014) to which fixing temperature calculated according to a printing mode is input are provided.

As indicated by an example shown in the table of FIG. 5, in each of the memories 30_{Y}, 30_{M} 30_{C}, and 30_{K} on the toner cartridges 27_{Y}, 27_{M}, 27_{C}, and 27_{K} side, an area (B001) to which an identification code is input, areas (B002 to B008) to which the correspondence data between humidity and a secondary transfer voltage (hereinafter, a data table of a secondary transfer voltage) is input, and areas (B009 to B015) to which the correspondence data between temperature and fixing temperature (hereinafter, a data table of fixing temperature) is input are provided for each of the addresses.

A plurality of the data tables of a secondary transfer voltage and a plurality of the data tables of fixing temperature are created in advance according to characteristics of the toners. An appropriate data table of a secondary transfer voltage is selected on the basis of the electric resistance, the charging amount, the average particle diameter, the particle size distribution, and the like of the toners. An appropriate data table of fixing temperature is selected on the basis of thermal characteristics such as Tm and Tg of the toners, thermal characteristics of resin, which is a material forming the toners, and the like.

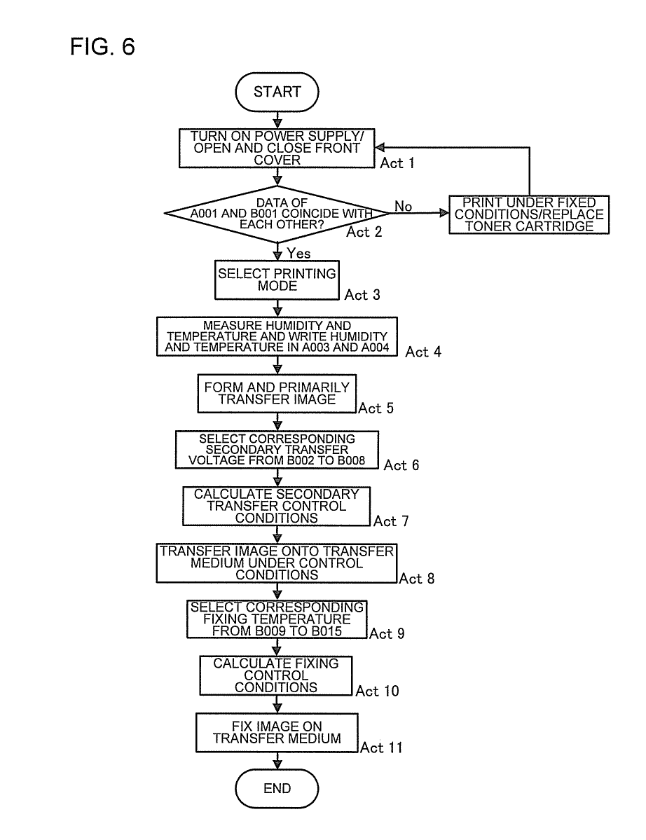

Control of the printing conditions is performed by such a configuration as explained below. A flowchart of the control is shown in FIG. 6. As shown in FIG. 6, in starting print, a front cover is opened and closed by, for example, turning on a power supply or replacing a toner cartridge (Act 1). It is determined whether identification codes input to the A001 of the memory 29 and B001 of the memory 30 coincide with each other (Act 2). If the identification codes coincide with each other, a print operation is performed. If the identification codes do not coincide with each other, a print operation under fixed conditions is performed or a toner cartridge is replaced.

A printing mode is selected by the user (Act 3). Humidity and temperature measured by the hygrometer 28A and the thermometer 28B are respectively written in A003 and A004 (Act 4). Image formation and primary transfer for the colors are respectively executed under predetermined conditions on the basis of the humidity and the like input to A003 (Act 5). If the full-color mode is selected, images are sequentially transferred onto the intermediate transfer belt 10 to be superimposed one on top of another. If the monochrome mode or the mono-color mode is selected, an image of only a selected color is transferred onto the intermediate transfer belt 10.

Correspondence data between humidity and secondary transfer voltage input to B002 to B008 in the memories 30 for the colors are read in the CPU 31 via the transmitting and receiving section 32. The CPU 31 selects secondary transfer voltages corresponding to the humidity input to the A003 respectively from B002 to B008 in the memories for the colors and writes the secondary transfer voltages in A005 to A008 (Act 6).

The CPU 31 calculates, from the secondary transfer voltages input to A005 to A008, optimum secondary transfer control conditions for the images of the plural colors, which are formed on the intermediate transfer belt 10 to be superimpose one on top of another, according to the printing mode input to A002 (Act 7).

At this point, for example, when toners of yellow, magenta, cyan, and black are used, if the secondary transfer voltages are represented as V_{Y}, V_{M}, V_{C}, and V_{K}, for example, an optimum secondary transfer voltage Vt can be calculated as follows:

color mode: Vt=(V_{Y}+V_{M}+V_{C}+V_{K})/4 or (V_{Y}+V_{M}+V_{C})/3

monochrome mode: Vt=V_{K}

mono-color mode: Vt=V_{Y} or V_{M} or V_{C}

The images on the intermediate transfer belt 10 are transferred onto the transfer medium 12 such as paper at the secondary transfer voltage Vt calculated in this way (Act 8).

Correspondence data between temperatures and fixing temperatures input to B009 to B015 in the colors are read in the CPU 31 via the transmitting and receiving section 32. The CPU 31 selects, from B009 to B015, fixing temperatures corresponding to the temperature input to A004 and writes the fixing temperatures in A009 to A012 (Act 9).

The CPU 31 calculates, from the fixing temperatures input to A009 to A012, optimum fixing control conditions for the images of the plural colors, which are formed on the transfer medium to be superimpose one on top of another, according to the printing mode input to A002 (Act 10).

At this point, for example, when toners of yellow, magenta, cyan, and black are used, if the fixing temperatures are represented as T_{Y}, T_{M}, T_{C}, and T_{K}, for example, optimum temperature T can be calculated as follows:

color mode: T=(T_{Y}+T_{M}+T_{C}+T_{K})/4 or (T_{Y}+T_{M}+T_{C})/3

monochrome mode: T=T_{K}

mono-color mode: T=T_{Y} or T_{M} or T_{C}

The images transferred onto the transfer medium 12 are fixed at the fixing temperature T calculated in this way (Act 11) and a desired image is formed.

### EXAMPLES

Examples are explained below.

### Preparation of Toners

Raw materials such as colorants, binder resin, releasing agents were mixed, fused, and kneaded. After the kneaded raw materials were crushed, the raw materials were classified and externally added agents were added to the raw materials, whereby toners of yellow (Y), magenta (M), cyan (C), and black (K) having different characteristics were formed. The toners maybe formed of chemical preparation such as polymerization.

### Evaluation of Transfer Characteristics

Concerning the toners formed in this way, electric resistance was measured. The measured electric resistance shifting higher than standard electric resistance was classified as H and the measured electric resistance shifting lower than the standard electric resistance was classified as L. According to such characteristic classifications, data tables of secondary transfer voltages were respectively selected. The selected data tables of secondary transfer voltages were written in an IC chip serving as a memory.

Humidity was measured and optimum secondary transfer conditions selected from data tables of the colors in examples were averaged, whereby optimum secondary transfer control conditions were calculated.

Halftone images of the colors were sequentially superimposed and formed under predetermined conditions on A3 color standard paper (Neusidler, 90g paper), secondarily transferred under the calculated control conditions, and fixed under predetermined conditions to obtain a sample. Concerning the obtained sample, an acceleration test was performed under an environment of 20% RH, 10° C. to 90% RH, 30° C. The sample was compared with a level sample and roughness (denseness) was evaluated, whereby a transfer state was evaluated as follows:

A: No roughness is observed

B: Roughness is observed in a part of the sample

C: Roughness is observed in the entire sample

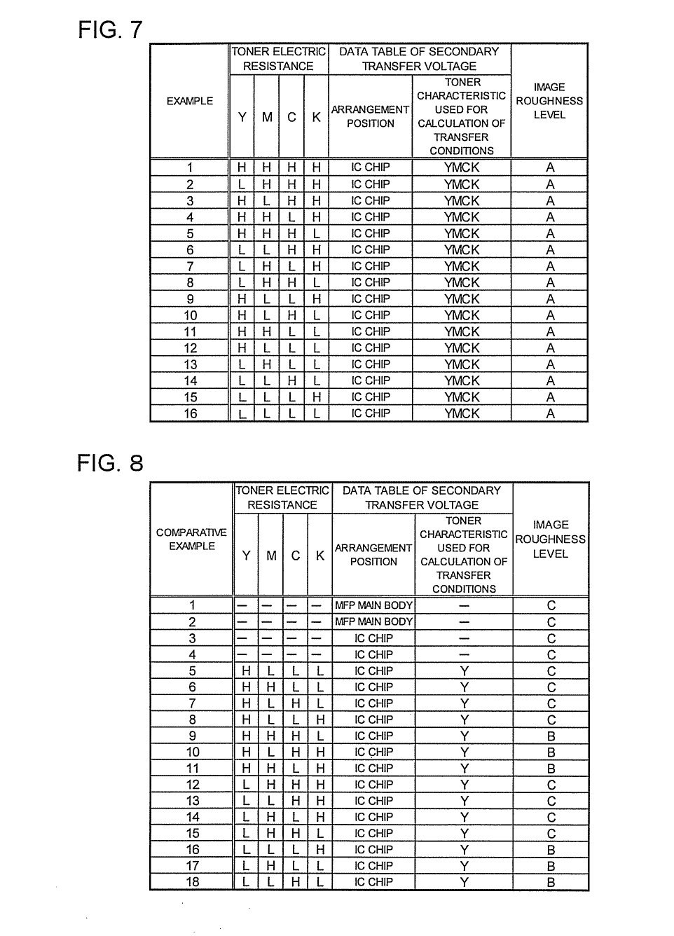

Evaluation results of transfer failures according to classifications of electric resistances of the toners in examples 1 to 16 are shown in a table of FIG. 7. As comparative examples, evaluation results obtained by secondarily transferring the halftone images under fixed conditions without taking into account electric resistances of the toners (comparative examples 1 to 4) and evaluation results obtained by secondarily transferring the halftone images at a secondary transfer voltage for yellow although the data tables of secondary transfer voltages were written in the IC chip as in the example (comparative examples 5 to 18) are shown in a table of FIG. 8.

As shown in the table of FIG. 7, satisfactory transfer states are shown in all the examples 1 to 16. On the other hand, as shown in the table of FIG. 8, roughness due to transfer failures occurs in all the comparative examples 1 to 18. In the comparative examples 1 to 18, the secondary transfer voltage for yellow was used. However, the same results were obtained when secondary transfer voltages for magenta, cyan, and black were used.

### Evaluation of Fixing Characteristics

Similarly, concerning the formed toners, softening temperature was measured. The measured softening temperature shifting higher than standard softening temperature was classified as H and the measured softening temperature shifting lower than the standard softening temperature was classified as L. According to such characteristic classifications, data tables of fixing temperatures were respectively selected. The selected data tables of fixing temperatures were written in an IC chip serving as a memory.

Temperature was measured and optimum fixing temperatures selected from the data tables of the colors in the examples were averaged, whereby optimum fixing control conditions were calculated.

Similarly, halftone images of the colors were sequentially superimposed and formed under predetermined conditions on A3 color standard paper (Neusidler, 90g paper), secondarily transferred under predetermined conditions, and fixed under the calculated control conditions to obtain a sample. Concerning the obtained sample, an acceleration test was performed under an environment of 20% RH, 10° C. to 90% RH, 30° C. The sample was compared with a level sample and image roughness was evaluated, whereby a fixing state was evaluated as follows:

A: No image roughness is observed

B: Image roughness is observed in a part of the sample

C: Image roughness is observed in the entire sample

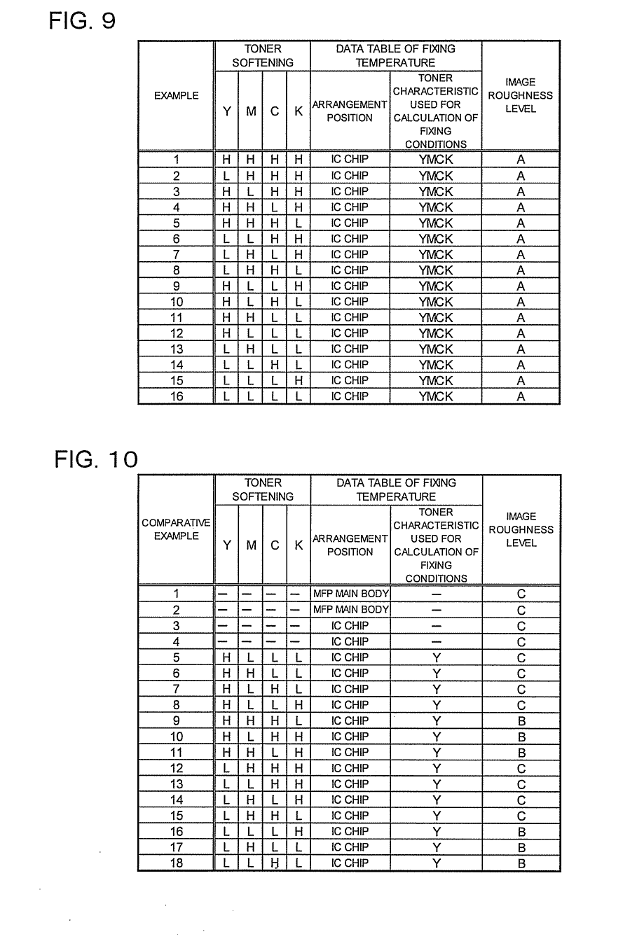

Evaluation results of transfer failures according to classifications of softening temperatures of the toners in examples 17 to 32 are shown in a table of FIG. 9. As comparative examples, evaluation results obtained by fixing the halftone images under fixed conditions without taking into account softening temperatures of the toners (comparative examples 19 to 22) and evaluation results obtained by fixing the halftone images at fixing temperature for yellow although the data tables of fixing temperatures were written in the IC chip as in the example (comparative examples 23 to 36) are shown in a table of FIG. 10.

As shown in the table of FIG. 9, satisfactory fixing states are shown in all the examples 17 to 32. On the other hand, as shown in the table of FIG. 10, image roughness due to transfer failures occurs in all the comparative examples 19 to 36. In the comparative examples 19 to 36, the fixing temperature for yellow was used. However, the same results were obtained when fixing temperatures for magenta, cyan, and black were used.

In this way, printing control conditions after primary transfer in the case of use of plural colors such as full color are set to conditions under which no substantial difference from optimum conditions in all the colors occurs. This makes it possible to obtain a satisfactory printing state. Consequently, it is possible to form a higher precision image.

While certain embodiments have been described, these embodiments have been presented by way of example only, and are not intended to limit the scope of the inventions. Indeed, the novel embodiments described herein may be embodied in a variety of other forms; furthermore, various omission, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image forming apparatus comprising:
plural image forming units including developing devices configured to respectively form images of plural colors;
plural toner cartridges in which respective toner of the plural colors is stored respectively and each of the plural toner cartridges configured to supply the respective toner to the developing device respectively;
first memories provided respectively incidental to the plural toner cartridges and each of the first memories in which correspondence data between parameter value affecting printing condition and printing condition calculated on the basis of characteristic of the respective toner of the plural colors is stored in advance;
a detecting mechanism configured to detect the parameter value; and
an arithmetic control mechanism configured to calculate each of printing conditions in the respective toner of plural colors from the correspondence data on the basis of the parameter value and calculate control condition for the image of the plural colors formed to be superimposed one on top of another on the basis of the printing condition.

2. The apparatus according to claim 1, wherein the first memories are attached to the plural toner cartridges or an integral unit including the toner cartridges.

3. The apparatus according to claim 1, further comprising a transmitting and receiving unit configured to connect the arithmetic control mechanism and the first memories by wire or wirelessly.

4. The apparatus according to claim 1, further comprising a second memory configured to store the detected parameter value and the calculated printing conditions.

5. The apparatus according to claim 1, further comprising a transfer member onto which the images of the plural colors respectively formed in the plural image forming units are transferred to be superimposed one on top of another.

6. The apparatus according to claim 1, further comprising a fixing device configured to fix an image transferred onto a transfer medium from the transfer member.

7. The apparatus according to claim 1, wherein the parameter value is at least one of humidity and temperature.

8. The apparatus according to claim 1, wherein the detecting mechanism is at least one of a hygrometer and a thermometer.

9. The apparatus according to claim 1, wherein the printing conditions and the control conditions are at least one of a secondary transfer voltage and fixing temperature.

10. The apparatus according to claim 1, wherein the correspondence data is selected on the basis of at least one of electric resistance, a charging amount, an average particle diameter, particle size distribution, and a thermal characteristic of the toner and a thermal characteristic of resin forming the toner.

11. The apparatus according to claim 1, wherein the arithmetic control mechanism averages the printing conditions to calculate the control condition.

12. An image forming method comprising:
supplying respective toner of plural colors to developing devices corresponding to the toner, correspondence data between parameter value affecting printing condition and the printing condition of the respective toner of the plural colors is stored in advance;
sequentially forming images of the plural colors with the respective toner of the plural colors;
detecting the parameter values;
calculating the printing condition in the respective toner of the plural colors on the basis of the detected parameter value respectively; and
calculating control condition for the image of the plural colors formed to be superimposed one on top of another, on the basis of the printing condition.

13. The method according to claim 12, wherein the parameter values are at least one of humidity and temperature.

14. The method according to claim 12, wherein the printing conditions and the control condition is at least one of a secondary transfer voltage and fixing temperature.

15. The method according to claim 12, further comprising secondarily transferring the images of the plural colors onto a transfer medium on the basis of the control condition.

16. The method according to claim 12, further comprising fixing the image of the plural colors on a transfer medium on the basis of the control condition.

17. The method according to claim 12, wherein the correspondence data is selected on the basis of at least one of electric resistance, a charging amount, an average particle diameter, particle size distribution, and a thermal characteristic of the toner and a thermal characteristic of resin forming the toner.

18. The method according to claim 12, wherein a printing mode is selected by a user.

19. The method according to claim 18, wherein the selected printing mode is a color mode.

20. The method according to claim 12, further comprising calculating the control condition by averaging the printing conditions.
